(19) United States
(12) Patent Application Publication
(10) Pub. No.: US 2026/0006621 A1
(43) Pub. Date: Jan. 1, 2026

(54) HYBRID MODE FRONTHAUL

(71) Applicant: OUTDOOR WIRELESS NETWORKS LLC, Richardson, TX (US)

(72) Inventors: Suman Saurav, Bhagalpur (IN); Theodore E. Dahlen, Burnsville, MN (US); Stuart D. Sandberg, Acton, MA (US)

(73) Assignee: Outdoor Wireless Networks LLC, Richardson, TX (US)

(21) Appl. No.: 19/131,779

(22) PCT Filed: Nov. 21, 2023
(86) PCT No.: PCT/US2023/080747

§ 371 Date: May 21, 2025

Related U.S. Application Data
(60) Provisional application No. 63/384,572, filed on Nov. 21, 2022.

(51) Int. Cl. H04W 72/231; H04L 27/36; H04W 72/21; H04W 76/10

(52) U.S. Cl. CPC H04W 72/231; H04L 27/364; H04W 72/21; H04W 76/10

(57) ABSTRACT

An open radio access network implementing a shared cell includes a distributed unit and radio units communicatively coupled to the distributed unit. Each radio unit includes circuitry for exchanging radio frequency signals with user equipment. Radio units include hybrid mode radio unit. first downstream radio unit, and second downstream radio unit. Hybrid mode radio unit is coupled to distributed unit. First downstream radio unit is coupled to distributed unit via hybrid mode radio unit. The second downstream radio unit is coupled to distributed unit via hybrid mode radio unit. Hybrid mode radio unit is configured to: (1) receive downlink control-plane and user-plane messages and uplink control-plane messages from distributed unit: (2) transmit downlink radio frequency signals from antenna(s), wherein downlink radio frequency signals are based on downlink control-plane and user-plane messages: and (3) copy and forward downlink control-plane. user-plane messages. and uplink control-plane messages to downstream radio units.

### CROSS-REFERENCE TO RELATED APPLICATIONS

This application claims the benefit of U.S. Provisional Patent Application Ser. No. 63/384,572, filed on Nov. 21, 2022 and entitled “HYBRID MODE FRONTHAUL”, which is hereby incorporated by reference in its entirety.

### BACKGROUND

The O-RAN Alliance promulgates a group of specifications for implementing radio access networks in an open manner. (“O-RAN” is acronym for “Open RAN.”) In O-RAN, each base station is typically implemented in a disaggregated manner in which each base station is partitioned into at least one central unit (CU), at least one distributed unit (DU), and one or more radio units (RUS). Each CU typically implements Layer 3 and non-time critical Layer 2 functions for the associated base station. Each DU is typically configured to implement the time critical Layer 2 functions and at least some of the Layer 1 (also referred to as the Physical Layer) functions for the associated base station. Each RU is typically configured to implement the radio frequency (RF) interface and the physical layer functions for the associated base station that are not implemented in the DU.

### SUMMARY

An open radio access network implementing a shared cell includes: a distributed unit; a plurality of radio units communicatively coupled to the distributed unit, wherein each of the plurality of radio units includes circuitry for exchanging radio frequency signals with at least one user equipment, wherein the plurality of radio units includes: a hybrid mode radio unit communicatively coupled to the distributed unit; a first downstream radio unit communicatively coupled to the hybrid mode radio unit, the first downstream radio unit communicatively coupled to the distributed unit via the hybrid mode radio unit; and a second downstream radio unit communicatively coupled to the hybrid mode radio unit, the second downstream radio unit communicatively coupled to the distributed unit via the hybrid mode radio unit; and wherein the hybrid mode radio unit is configured to: receive downlink control-plane messages, downlink user-plane messages, and uplink control-plane messages from the distributed unit; transmit downlink radio frequency signals from one or more antennas, wherein the downlink radio frequency signals are based on the downlink control-plane messages and the downlink user-plane messages; and copy and forward the downlink control-plane messages, the downlink user-plane messages, and the uplink control-plane messages to a plurality of downstream radio units of the plurality of radio units.

A radio unit for use within an open radio access network having a distributed unit and implementing a shared cell includes circuitry configured to: receive downlink control-plane messages, downlink user-plane messages, and uplink control-plane messages from the distributed unit; transmit downlink radio frequency signals from one or more antennas, wherein the downlink radio frequency signals are based on the downlink control-plane messages and the downlink user-plane messages; and copy and forward the downlink control-plane messages, the downlink user-plane messages, and the uplink control-plane messages to a plurality of downstream radio units.

A downstream radio unit for use within an open radio access network having a distributed unit and implementing a shared cell includes circuitry configured to: receive an advertisement of capacity available for copy and combine functions for downstream radio units from a hybrid mode radio unit; determine whether first capacity available for the hybrid mode radio unit is sufficient for the downstream radio unit based on second capacity required by the downstream radio unit; communicate an indication that the capacity available for the copy and combine functions is sufficient to meet requirements for first copy and combine functions of the downstream radio unit; and establish a connection between the downstream radio unit and the hybrid mode radio unit when the capacity available for the copy and combine functions is sufficient to meet the requirements for the first copy and combine functions of the downstream radio unit.

A method for communication within an open radio access network having a distributed unit and implementing a shared cell includes: receiving downlink control-plane messages, downlink user-plane messages, and uplink control-plane messages from the distributed unit at a radio unit; transmitting downlink radio frequency signals from one or more antennas at the radio unit, wherein the downlink radio frequency signals are based on the downlink control-plane messages and the downlink user-plane messages; and copying and forwarding the downlink control-plane messages, the downlink user-plane messages, and the uplink control-plane messages from the radio unit to a plurality of downstream radio units.

### BRIEF DESCRIPTION OF DRAWINGS

Understanding that the drawings depict only exemplary configurations and are not therefore to be considered limiting in scope, the exemplary configurations will be described with additional specificity and detail through the use of the accompanying drawings, in which:

FIGS. 1A-1B are block diagrams illustrating an exemplary embodiment of a communication system in which the techniques described below can be used.

FIG. 2 is a block diagram illustrating an example communication system that includes a portion of the broader communication system shown in FIGS. 1A-1B; and

FIG. 3A is a block logical link diagram showing a system having an O-DU and a plurality of O-RUs, some of which are operating in a hybrid mode.

FIG. 3B is a timing diagram showing delay management in the downlink of the system of FIG. 3A.

FIG. 3C is a timing diagram showing delay management in the uplink of the system of FIG. 3A.

FIG. 4 is a flow diagram illustrating an example method for downlink hybrid operation of an RU.

FIG. 5 is as flow diagram illustrating an example method for uplink hybrid operation of an RU.

FIG. 6 is a flow diagram illustrating an example method for dynamic cluster formation within an O-RAN having a DU and implementing the O-RAN shared cell implementation.

FIG. 7 illustrates one example of the dynamic cluster formation processing of the method of FIG. 6 being performed in the example system of FIG. 3A.

In accordance with common practice, the various described features are not drawn to scale but are drawn to emphasize specific features relevant to the exemplary configurations.

### DETAILED DESCRIPTION

In O-RAN, each base station is typically implemented in a disaggregated manner in which each base station is partitioned into at least one central unit (CU), at least one distributed unit (DU), and one or more radio units (RUs). Used herein, the term “north” or “northbound” means “upstream” or toward the DU, while the term and the term “south” or “southbound” means “downstream” or away from the DU.

The O-RAN specifications define a “shared cell” configuration or implementation in which a single cell is served using multiple RUs. The O-RAN shared cell implementation attempts to make more efficient use of bandwidth to and from DUs (compared to O-RAN 1.0) in order to support communicating front-haul data with the multiple RUs. The O-RAN shared cell implementation is described in detail at Section 13 “Support of Shared Cell” in the O-RAN Working Group 4 (Open Fronthaul Interfaces WG) Control, User and Synchronization Plane Specification version 10.0 from October 2022 (O-RAN.WG4.CUS.0-v10.00, hereinafter “Support of Shared Cell O-RAN Specification”, available at pages 252-270 of PDF at https://orandownloadsweb.azurewebsites.net/download?id=364). In the O-RAN shared cell implementation, there are generally two modes of operation in the fronthaul: Fronthaul Multiplexer (FHM) mode and Cascade mode. Examples implementing a shared cell include a FHM in order to more efficiently support one-DU-to-many-RU mapping. In examples, the FHM: (1) replicates the downlink packet stream (from the DU) for each RU; and (2) uses combining/digital summation on the uplink packet stream from the RUs (before sending to the DU). The combining/digital summation includes: (1) adding the corresponding in-phase (I) samples in corresponding physical resource blocks (PRBs) (from all the RUs); (2) adding the corresponding quadrature-phase (Q) samples in corresponding PRBs (from all the RUs); and (3) sending a combined stream of I/Q data from the FHM to the DU. The combining/digital summation may optionally include some overflow management. Using the shared cell implementation, the DU can send and receive a single packet stream (with a bandwidth of approximately N PRBs) instead of M packet streams (one for each RU with a total bandwidth of approximately N PRBs x M RUs). By reducing the DU transmitted and received data to a single stream of N PRBs, the shared cell implementation reduces bandwidth (between the DU and multiple RUs).

In examples, using the FHM mode shared cell implementation requires the use of a FHM. A FHM may be limited in how many RUs can connect to it (such as no more than 8 RUs in examples). The O-RAN specifications also defines a “hybrid” Cascade-FHM mode in which a first FHM has one or more FHMs directly subtended from that first FHM. In this hybrid Cascade-FHM mode, only two levels of FHMs are permitted due to concerns about the impact that deeper chains may have on the noise floor level and on delay management and the belief that two FHM levels are sufficient for typical indoor usage scenarios. In examples, multiple FHM are cascaded from one another to support larger quantities of RUs. In examples, FHMs can only be cascaded for two levels. In examples, the depth of the FHM is limited because: (1) the noise floor level may have negative impact when a deeper chain is constructed; (2) delay management may be affected by deeper chains; (3) Cascade-FHM mode is suitable to be deployed in indoor distribution systems where usage with two cascaded FHMs is generally typically and sufficient. In examples limited to 8 RUs per FHM, additional FHMs are required for more than 8 RUs, thereby adding extra cost to deployment with more than 8 RUs. In examples, at least 32 to 128 RUs used per cell require 4 to 16 FHMs, which may not bring additional benefit other than reducing fronthaul bandwidth by a copy and combine function. This is because each FHM only implements front-haul transport functionality and does not include radio functionality for transmitting and receiving RF signals with UEs. FHM mode operations may also be limited to star topology and hybrid Cascade FHM modes. In Cascade mode, the RUs are arranged in a daisy-chain where each Cascade mode RU can also provide copy-and-combine functionality with all the additional functionalities of an RU at minimum extra processing cost. Cascade mode RUs act as copy-and-forward nodes from north to south for downlink and combine-and-forward nodes in the uplink. Therefore, Cascade mode RUs have not historically combined IQ data of multiple RUs or copy and forward signals to multiple RUs. In examples, multicast is used in the downlink to reduce fronthaul bandwidth and unicast is used in the uplink.

In implementations described herein, at least some Cascade mode RUs are configured to operate in a “hybrid mode” that combines FHM mode and Cascade mode operations. While operating in a hybrid mode, a single hybrid mode RU acts as a cluster head which copies and forwards IQ data from north to south in the downlink and combines and forwards IQ data from south to north in the uplink. Depending on the available processing capacity, an RU (operating in a hybrid mode and acting as a cluster head) can allow several south-bound RUs to connect to it and forward combined IQ data in the uplink to reduce fronthaul bandwidth. Similarly, the RUs operating in the hybrid mode provide copy function in the downlink reducing fronthaul bandwidth link from the DU.

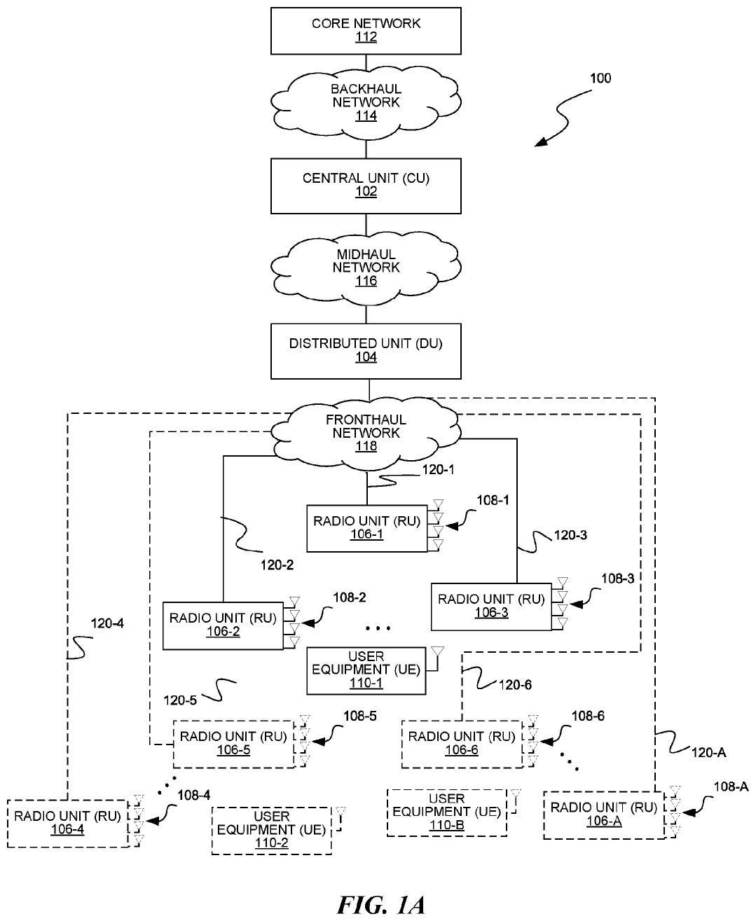

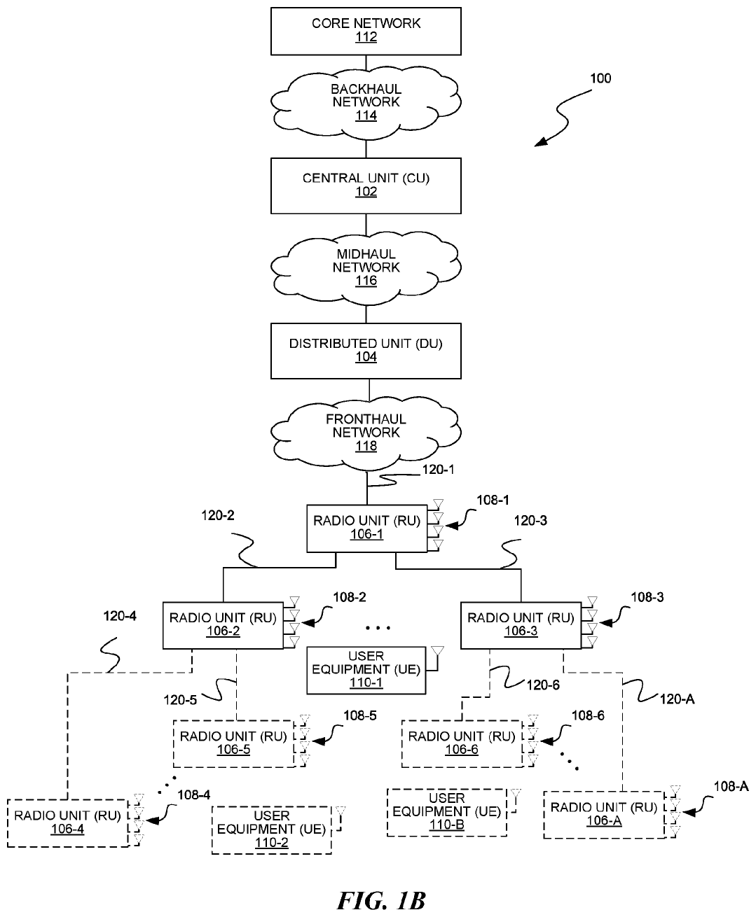

FIGS. 1A-1B are block diagrams illustrating an example of a communication system 100. FIG. 1A shows an example physical topology, while FIG. 1B shows an example logical topology. In the example shown in FIGS. 1A-1B, the communication system 100 is implemented using an O-RAN or other point-to-multipoint distributed base station architecture. The communication system 100 may also be referred to here as a “O-RAN” or a “O-RAN system.” In examples, communication system 100 includes at least one central unit (CU or O-CU) 102, at least one distributed unit (DU or O-DU) 104, and at least one radio unit (RU or O-RU) 106 (such as radio unit (RU) 106-1 and any quantity of optional radio unit (RU) 106-2 through optional radio unit (RU) 106-A) configured to serve at least one user equipment (UE) 110 within the site at which wireless services is being provided.

In examples, the at least one CU 102, at least one DU 104, and at least one RU 106 implement a “base station”, “base station entity”, or “base station system” (which in the context of a fourth generation (4G) Long Term Evolution (LTE) system, may also be referred to as an “evolved NodeB”, “eNodeB”, or “eNB”; in the context of a fifth generation (5G) New Radio (NR) system, may also be referred to as a “gNodeB” or “gNB”; and may take different names in other current or future generations of radio access networks (RAN) and communication networks). In examples, the at least one CU 102 and/or at least one DU 104 are located remotely from the site at which wireless service is being provided, e.g., in centralized banks of nodes. Additionally, the RUs 106 may be physically separated from each other at the site at which wireless service is being provided, although they are each communicatively coupled to at least one DU 104 via the at least one fronthaul network 118. A base station may be used to provide UEs 110 with mobile access to the wireless network operator's core network 112 to enable UEs 110 to wirelessly communicate data and voice (using, for example, Voice over LTE (VoLTE) technology or a 3GPP 5G RAN providing wireless service using a 5G air interface).

In examples, the communication system 100 implements a base station as a respective 5G NR gNB (only one of which is shown in FIGS. 1A-1B for ease of illustration). In such a configuration, each CU 102 implements Layer 3 and non-time critical Layer 2 functions for the 5G NR gNB. In examples, each CU 102 may be further partitioned into at least one control-plane entity (“CU-CP”) and at least one user-plane entity (“CU-UP”) that handle the control-plane and user-plane processing of the CU 102, respectively. In examples, each DU 104 is configured to implement the time critical Layer 2 functions and, except as described below, at least some of the Layer 1 functions for the gNB. In this example, each RU 106 is configured to implement the physical layer functions for the gNB that are not implemented in the DU 104 as well as the RF interface. Also, each RU 106 includes or is coupled to a respective set of one or more antennas 108 (such as any of antenna(s) 108-1, antennas(s) 108-2, antennas(s) 108-3, and any quantity of antennas 108-4 through 108-A) used to radiate downlink RF signals to UEs 110 and receive uplink RF signals transmitted by UEs 110.

In general, the communication system 100 is configured to provide wireless service to various items of user equipment (UEs) 110 (such as user equipment (UE) 110-1 and any quantity of optional user equipment (UE) 110-2 through optional user equipment (UE) 110-B). Unless explicitly stated to the contrary, references to Layer 1, Layer 2, Layer 3, and other or equivalent layers (such as the Physical Layer or the Media Access Control (MAC) Layer) refer to layers of the particular wireless interface (for example, Fourth Generation (4G) Long Term Evolution (LTE) or Fifth Generation (5G) New Radio (NR)) used for wirelessly communicating with UEs 110. Furthermore, it is also to be understood that 5G NR embodiments can be used in both standalone and non-standalone modes (or other modes developed in the future) and the following description is not intended to be limited to any particular mode. Moreover, although some embodiments are described here as being implemented for use with 5G NR, other embodiments can be implemented for use with other wireless interfaces and the following description is not intended to be limited to any particular wireless interface.

In examples, the at least one CU 102 is communicatively coupled to at least one corresponding core network 112 of the associated wireless operator via at least one backhaul network 114. The at least one backhaul network 114 is typically a public wide area network such as the Internet, though it is understood that the at least one backhaul network 114 can be implemented in other ways. In examples, at least one DU 104 is communicatively coupled to at least one CU 102 via at least one midhaul network 116. In examples, the midhaul interface promulgated by the O-RAN Alliance is used for the midhaul network 116 between the DU 104 and the at least one CU 102. In examples, at least one RU 106 is communicatively coupled to at least one DU 104 via at least one fronthaul network 118. In examples, the fronthaul interface promulgated by the O-RAN Alliance is used for the fronthaul network 118 between each RU 106 and a respective DU 104. In examples, each of the backhaul network 114, the midhaul network 116, and/or the fronthaul network 118 may be implemented with one or more switches, routers, and/or other networking devices. In some examples, the backhaul network 114, the midhaul network 116, and/or the fronthaul network 118 may be implemented with switched Ethernet using a switched Ethernet network and an Ethernet switch.

Although FIGS. 1A-1B (and the description set forth herein more generally) is described in the context of 5G embodiments where each logical base station entity is partitioned into a CU 102, DUs 104, and RUs 106 and, for at least some of the physical channels, some physical-layer processing is performed in the DUs 104 with the remaining physical-layer processing being performed in the RUs 106, it is to be understood that the techniques described here can be used with other wireless interfaces (for example, 4G LTE) and with other ways of implementing a base station entity (for example, using a conventional baseband band unit (BBU)/remote radio head (RRH) architecture). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

Each CU 102, DU 104, and RU 106, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in a field programmable gate array (FPGA), application specific integrated circuit (ASIC), etc.).

Moreover, each CU 102, DU 104, and RU 106, can be implemented as a physical network function (PNF) (for example, using dedicated physical programmable devices and other circuitry) and/or a virtual network function (VNF) (for example, using one or more general purpose servers (possibly with hardware acceleration) in a scalable cloud environment and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF). For example, in the exemplary embodiment shown in FIGS. 1A-1B, each RU 106 is implemented as a PNF and is deployed in or near a physical location where radio coverage is to be provided and each CU 102 and DU 104 is implemented using a respective set of one or more VNFs deployed in a distributed manner within one or more clouds (for example, within an “edge” cloud or “central” cloud). Each CU 102, DU 104, and RU 106, and any of the specific features described here as being implemented thereby, can be implemented in other ways.

The links shown in the communication system 100 in FIG. 1A shows all the RUs 106 being connected to the fronthaul network 118 (which could be implemented with one or more switches, routers, and/or other networking devices. In contrast, the links shown in the communication system 100 in FIG. 1B are logical links and the actual physical links between devices in the backhaul network 114, the midhaul network 116, and/or the fronthaul network 118 may be implemented using different media, such as conductive media (copper, multi-rate, multi-mode cables, etc.) and optical media (fiber optic cables). In examples, each RU 106 and each physical node on which each DU 104 is implemented includes one or more Ethernet network interfaces to couple each RU 106 and each physical node implementing the DU 104 to the fronthaul network 118 in order to facilitate communications between the DU 104 and the RUs 106.

The RUs 106 may be deployed at a site to provide wireless coverage and capacity for one or more wireless network operators. The site at which wireless service is being provided may cover, for example, a building or campus or other grouping of buildings (used, for example, by one or more businesses, governments, other enterprise entities) or some other public venue (such as a hotel, resort, amusement park, hospital, shopping center, university campus, arena, or an outdoor area such as a ski area, stadium or a densely populated downtown area). In some configurations, the site at which wireless service is being provided is at least partially (and optionally entirely) indoors, but other alternatives are possible.

Each UE 110 may be a computing device with at least one processor that executes instructions stored in memory, e.g., a mobile phone, tablet computer, mobile media device, mobile gaming device, laptop computer, vehicle-based computer, a desktop computer, etc.

Each CU 102, DU 104, and RU 106 can be implemented so as to use an air interface that supports one or more of frequency-division duplexing (FDD) and/or time-division duplexing (TDD). Also, the CU 102, DUs 104, and RUs 106 can be implemented to use an air interface that supports one or more of the multiple-input-multiple-output (MIMO), single-input-single-output (SISO), single-input-multiple-output (SIMO), and/or beam forming schemes. For example, the CU 102, DUs 104, and RUs 106 can implement one or more of the 5G NR transmission modes. Moreover, the communication system 100 can be configured to support multiple air interfaces and/or to support multiple wireless operators.

In examples in the downlink, the DU 104 communicates downlink control-plane messages, downlink user-plane messages, and uplink control-plane messages to the RU 106-1, which uses the downlink control-plane and downlink user-plane messages to wirelessly transmit downlink radio frequency signals using a respective set of antennas 108 for reception by UEs 110 and also copies and forwards the downlink control-plane messages, downlink user-plane messages, and uplink control-plane messages toward both RU 106-2 and RU 106-3. RU 106-2 and RU 106-3 also use the downlink control-plane messages and downlink user-plane messages to wirelessly transmit radio frequency signals using a respective set of antennas 108 for reception by UEs 110 and (if operating in a hybrid mode or a cascade mode) further copy and forward the downlink control-plane messages, downlink user-plane messages, and uplink control-plane messages toward RU 106-4, RU 106-5, RU 106-6, and RU 106-A as appropriate. These further RU 106-4, RU 106-5, RU, 106-6, and RU 106-A can also operate in hybrid mode and additional RUs 106 can be included and also operate in a hybrid mode (or operate in a cascade mode or just operate as a radio unit without being in a hybrid or cascade mode).

In examples in the uplink, the RU 106-1 wirelessly receives uplink radio frequency signals transmitted from UEs 110 using the respective set of antennas 108 and generates uplink user-plane data from the received RF signals, and also combines user data received from both RU 106-2 and RU 106-3. RU 106-2 and RU 106-3 wirelessly receive on air media using an antenna and: (1) if operating in a hybrid mode, further combine data received from two of RU 106-4, RU 106-5, RU 106-6, and RU 106-A with the data received on the air media as appropriate; or (2) if operating in a cascade mode, further combine data received from one of RU 106-4, RU 106-5, RU 106-6, and RU 106-A with the data received on the air media as appropriate. In examples, the combining is an uplink summation. In examples, the combining is uplink coherent combining that requires phase information for the data.

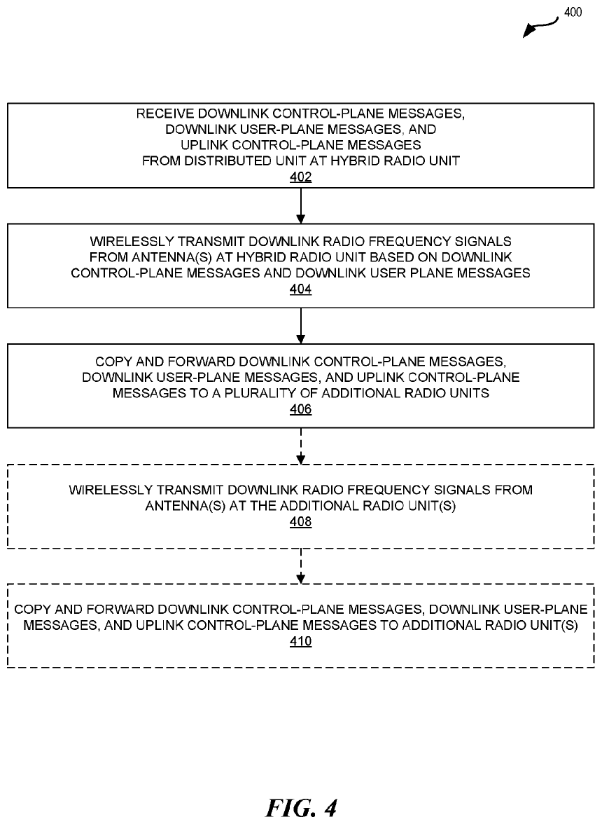

In examples in the uplink, for each uplink slot, the serving DU schedules one or more UEs to transmit during that slot. In examples, the DU sends uplink control-plane messages to each RU identifying the resource blocks (RBs) for which the RU should provide baseband IQ data. The RBs for which the RU should provide baseband IQ data are also referred to here as “front-hauled RBs.” The uplink control-plane messages are subjected to the copy-and-forward process described above in connection with FIG. 4.

In embodiments where the baseband IQ data communicated over the fronthaul comprises frequency-domain baseband IQ data, the front-hauled RBs comprise only those RBs that have been assigned to the scheduled UEs for uplink transmissions during that slot. In embodiments where the baseband IQ data communicated over the fronthaul comprises time-domain baseband IQ data, the front-hauled RBs comprise all of the RBs for the slot (due to the time-domain nature of the baseband IQ data).

During each uplink slot, for each antenna port, each RU generates respective baseband IQ data for each front-hauled RB from a uplink RF analog signal received via a respective one of the antennas associated with that RU.

For each “terminal” or “leaf” RU (that is, any RU that does not have any southbound RUs coupled to it), for each uplink slot, the terminal RU generates uplink user-plane message that include the baseband IQ data generated at that terminal RU for the various front-hauled RBs and antenna ports and communicates the uplink user-plane messages northbound.

For each hybrid-mode RU, for each uplink slot, that RU performs a combine-and-forward process that involves receiving, from its southbound RUs, uplink user-plane messages containing baseband IQ data for the front-hauled RBs and performing a combining process that uses, as inputs, the baseband IQ data contained in the received user-plane messages as well as the baseband IQ data generated at that RU. This combining process is performed, for each front-hauled RB, on a symbol-by-symbol and antenna-port-by-antenna-port basis. That is, for each antenna port, the combining RU combines the baseband IQ for each symbol of each front-hauled RB (for example, by digitally summing the corresponding I values received by, and generated at, that combining RU for that symbol and by digitally summing the corresponding Q values received by, and generated at, that combining RU for that symbol). The combining RU generates uplink user-plane messages that include the resulting combined baseband IQ data for the various front-hauled RBs and antenna ports and communicates the uplink user-plane messages northbound.

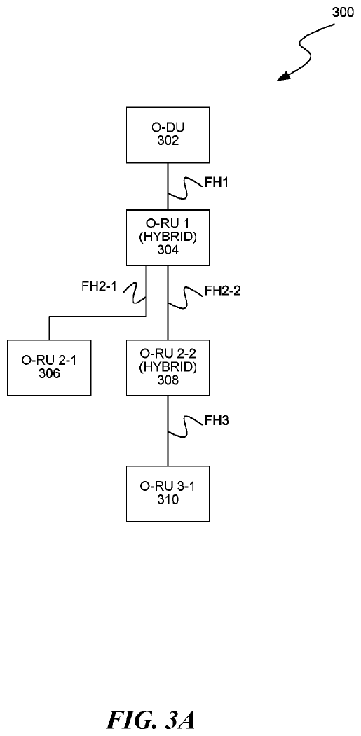

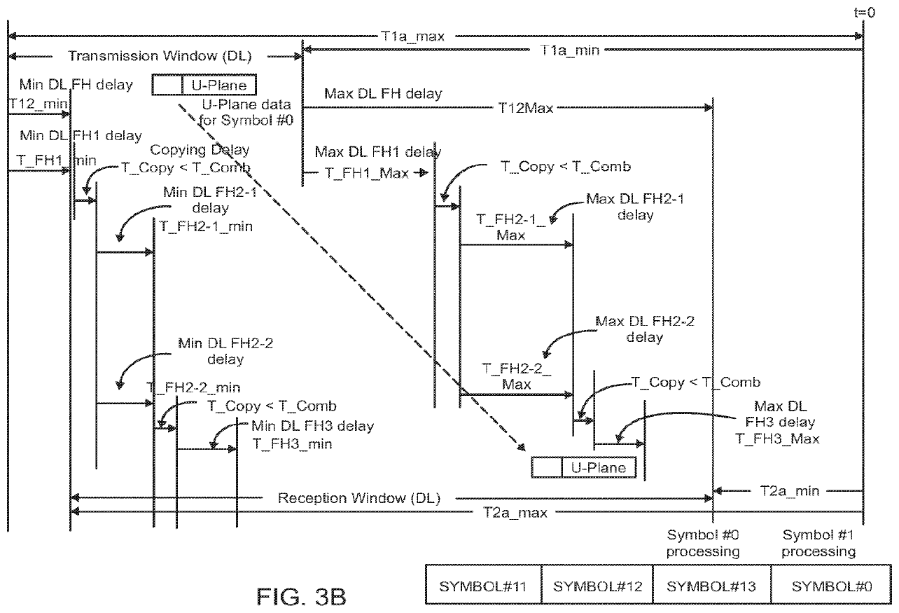

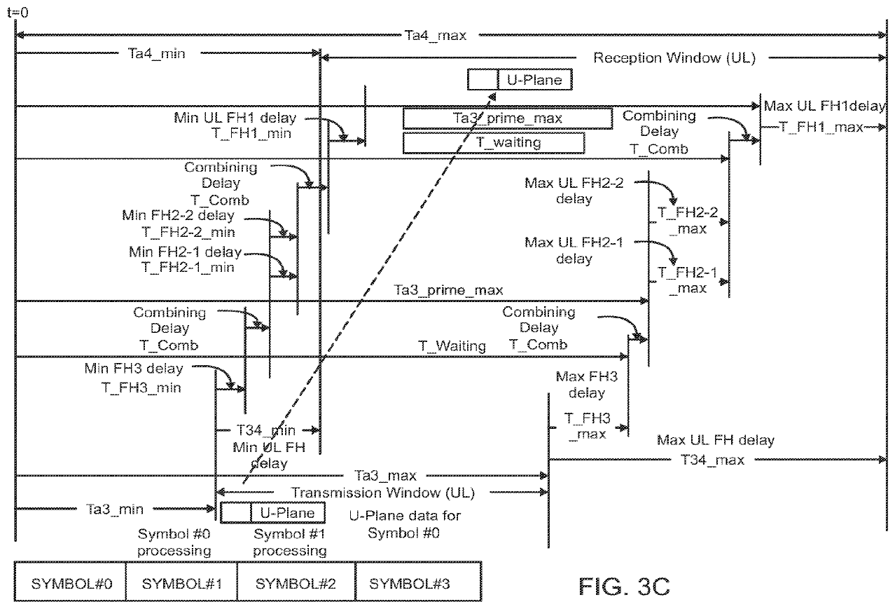

In examples, downlink and uplink delay management are used to properly setup the reception window and transmission window within the system based on the system topology as described in further detail with reference to FIGS. 3A-3C below.

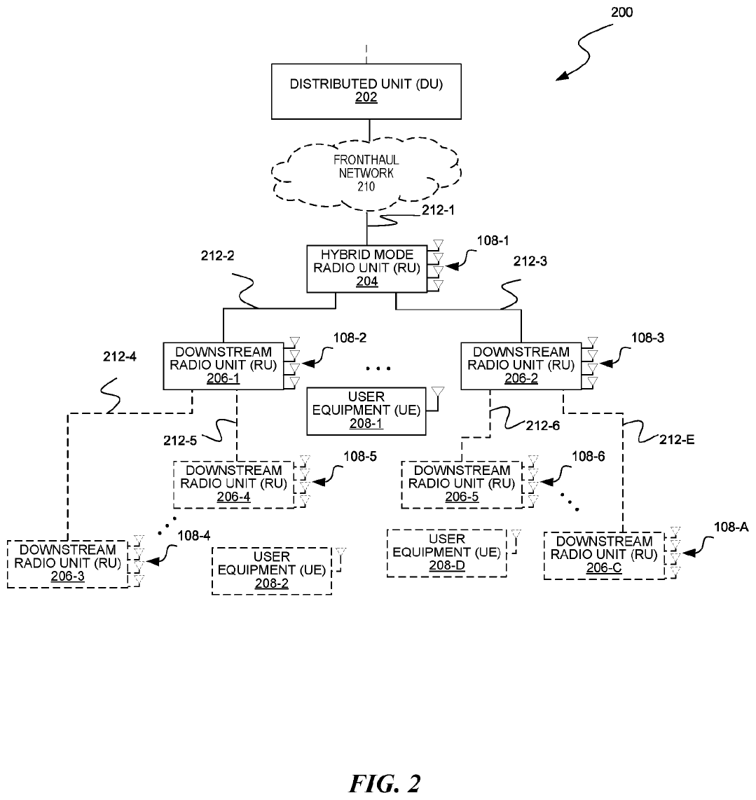

FIG. 2 is a block diagram illustrating an example of a communication system 200 where the links between the hybrid mode RU and the downstream RUs shown in FIG. 2 are logical links. In the example shown in FIG. 2, the communication system 200 is implemented using an O-RAN or other point-to-multipoint distributed base station architecture. In examples, communication system 200 includes a distributed unit (DU or O-DU) 202 (which can be an implementation of DU 104 in FIG. 1A or FIG. 1B as described herein), at least one hybrid mode radio unit (RU or O-RU) 204 (which can be an implementation of a RU 106 in FIG. 1A or FIG. 1B as described herein), and a plurality of downstream radio units (RUs or O-RUs) 206 (such as downstream radio unit (RU or O-RU) 206-1, downstream radio unit (RU or O-RU) 206-2, and any quantity of optional downstream radio unit (RU or O-RU) 206-3 through optional downstream radio unit (RU or O-RU) 206-C which can be implementations of RU 106 in FIG. 1A or FIG. 1B as described herein) configured to serve at least one user equipment (UE) 208 (such as user equipment (UE) 208-1 through user equipment (UE) 208-D which can be implementations of UE 110 in FIG. 1A or FIG. 1B as described herein). In examples, the at least one hybrid mode RU 204 is communicatively coupled to the DU 202 through a fronthaul network 210. In examples, any of the downstream radio units (RU or O-RU) 206 are also hybrid mode RUs 204 and also have a plurality of downstream radio units (RUs or O-RUs) 206 communicatively coupled to them (such as when downstream radio unit (RU) 206-1 supports a plurality of optional downstream radio units, such as optional downstream radio unit (RU) 206-3 and optional downstream radio unit (RU) 206-4 and any quantity of optional additional downstream radio units (RU) 206; or when downstream radio unit (RU) 206-2 supports a plurality of optional downstream radio units, such as optional downstream radio unit (RU) 206-5 and optional downstream radio unit (RU) 206-C and any quantity of additional optional downstream radio units (RU) 206).

In examples, the hybrid mode RU 204 is communicatively coupled to the distributed unit via a first communication link 212-1. In examples, a first downstream RU 206-1 is communicatively coupled to the hybrid mode RU 204 via a second communication link 212-2 such that the first downstream RU 206-1 is communicatively coupled to the DU 202 via the hybrid mode RU 204. In examples, a second downstream RU 206-2 is communicatively coupled to the hybrid mode RU 204 via a third communication link 212-3 such that the second downstream RU 206-2 is communicatively coupled to the DU 202 via the hybrid mode RU 204.

In examples, the hybrid mode RU 204 is configured to advertise capacity available for copy and combine functions for downstream RUs to the downstream RUs 206 (such as any of first downstream RU 206-1 through downstream RU 206-C) across the communication links 212 (such as any of communication link 212-1 through communication link 212-E). In examples, the capacity available for copy and combine functions for downstream RUs is advertised in bandwidth. In examples, the advertised capacity available for copy and combine functions for downstream RUs is communicated through the hierarchy of downstream RUs 208 such that downstream RUs 208 forward the advertised capacity available for copy and combine functions received from northbound RUs to southbound RUs. In examples, prior to the hybrid mode RU 204 advertising capacity available for copy and combine functions for downstream RUs, the DU (such as DU 202 or DU 104) configures and informs the RUs (such as hybrid mode RU 204 and downstream RUs 206 in FIG. 2 or RUs 106 in FIG. 1A or FIG. 1B) about south bounded RUS (such as downstream RUs 206 in FIG. 2 or RUs 106-1 through 106-A in FIG. 2) available on the link. In examples, the RUs (such as downstream RU 206-1 and downstream RU 206-2 in FIG. 2 or RU 106-2 and RU 106-3 in FIG. 1A or FIG. 1B) have south bounded RUs (such as downstream RU 206-3, downstream RU 206-4, downstream RU 206-5, and downstream RU 206-C in FIG. 2 and RU 106-4, RU 106-5, RU 106-6, and RU 106-A in FIG. 1A or FIG. 1B) send indications to north bounded RUs (such as hybrid mode RU 204 in FIG. 2 and RU 106-1 in FIG. 1A or FIG. 1B) after connecting with the south bounded RUs (such as downstream RU 206-3, downstream RU 206-4, downstream RU 206-5, and downstream RU 206-C in FIG. 2 and RU 106-4, RU 106-5, RU 106-6, and RU 106-A in FIG. 1A or FIG. 1B).

In examples, any particular downstream RU 206 of the downstream RUs 206 (such as any of downstream RU 206-1 through downstream RU 206-C) may respond to the advertisement of capacity from the downstream RU 206-1 with an indication that the capacity available for the copy and combine functions is sufficient to meet the requirements for copy and combine functions of the particular downstream RU 206. In examples, a connection is then established between the hybrid mode RU 204 and the particular downstream RU 206 when the capacity available for the copy and combine functions is sufficient to meet the requirements for the copy and combine functions of the particular downstream radio unit.

In examples, there are two ways for cluster formation: (1) static cluster formation; and (2) dynamic cluster formation. In static cluster formation, depending on the deployment map and available infrastructure, RUs are interconnected in cluster formation, reducing the fronthaul bandwidth. In dynamic cluster formation, clustering algorithms (such as fuzzy and/or hierarchical clustering) can dynamically connect to the nearest cluster head to optimize the fronthaul bandwidth. In examples implementing hierarchical clustering, multiple hybrid mode RUs can group at different levels based on metrics, such as the number of hops from the DU 202 and/or the maximum delay from the DU 202. In examples, multiple hybrid mode RUs can be created at the same level based on deployment requirements.

In examples, use of the hybrid mode RUs (such as hybrid mode RU 204 in FIG. 2 or RU 106-1 in FIG. 1A or FIG. 1B) enables easy scaling without requiring extra effort to maintain a list of multicast addresses at the DU and inducing a fault management procedure to check if all links are active. In examples where an FHM can only support 2 RUs with 4×4 and 4-carrier SCS 30 kHz 100 MHz wide bandwidth with 8 10G ports, to support 32 RUs deployment, 16 FHMs would be necessary, which is expensive and complicated. In examples, increasing the existing RUs' processing capability to support the above requirement would be less costly. In examples implementing hybrid RUs, fronthaul dependency on Radio Resource Management (RRM) configuration can be reduced.

In examples, hybrid mode RUs (such as hybrid mode RU 204 in FIG. 2 or RU 106-1 in FIG. 1A or FIG. 1B) need extra processing capability for copying and combining functions. Based on available processing capability at the RUs, the number of combined operations can be limited, which results in a limited number of RUs being able to connect to the cluster head. In examples, current RUs may be able to be used, though modifications may need to be made to the hardware or software configurations. In an example using CommScope ONECELL RP5200 RUs, O-RAN processing may need to be enabled on second 10 Gbps port and some additional memory may need to be added or allocated for the uplink summing. In examples, lookup table (LUT), Flip-Flops (FF), and Ultra Random Access Memory (URAM) may need to be increased or re-allocated.

Each CU 102, DU 104, and RU 106, and any of the specific features described here as being implemented thereby, can be implemented in other ways. Additionally, it should be noted that the systems and methods described herein may also be used in other distributed RANs, e.g., a distributed antenna system (DAS).

FIG. 3A is a block logical link diagram showing a system 300 having an O-DU 302 and a plurality of O-RUs (O-RU 1 (HYBRID) 304, O-RU 2-1 306, O-RU 2-2 (HYBRID) 308, and O-RU 3-1 310), some of which are operating in a hybrid mode. FIG. 3B is a timing diagram showing delay management in the downlink of the system 300 of FIG. 3A. FIG. 3C is a timing diagram showing delay management in the uplink of the system 300 of FIG. 3A. In addition to the specific description below with reference to FIGS. 3A-3C, other aspects shown in the timing diagrams are described in the Support of Shared Cell O-RAN Specification.

System 300 includes O-DU 302, O-RU 1 (HYBRID) 304, O-RU 2-1 306, O-RU 2-2 (HYBRID) 308, and O-RU 3-1 310. O-RU 1 (HYBRID) 304 is logically connected to O-DU 302 via logical connection FH1. O-RU 2-1 306 is logically connected to O-RU 1 (HYBRID) 304 via logical connection FH2-1. O-RU 2-2 (HYBRID) 308 is logically connected to O-RU 1 (HYBRID) 304 via logical connection FH2-2. O-RU 3-1 310 is logically connected to O-RU 2-2 (HYBRID) 308 via logical connection FH3.

FIG. 3B details the DL delay model parameters where O-RU 1 and O-RU 2-2 are operating in hybrid mode, however, O-RU1 is performing the task of FHM, and O-RU2-2 is operating in a Cascade mode. In examples, for DL U-Plane messages to arrive at the O-RU within the O-RU reception window, the configuration of fronthaul including hybrid O-RUs need to satisfy relationships, similar to those described in section 13.5 of the Support of Shared Cell O-RAN Specification. In examples, it is necessary that inequality equation(s) be satisfied for the DL U-plane message to arrive at the O-RU within the O-RU reception window. In examples, a change will be seen in N (number of southbounded O-RU connecting to north node) which will not be the total number of O-RUs serving the Mth cell. In examples according to FIG. 3B: (1) T_FH1_min is the minimum transport delay between O-RU#1 and O-DU; (2) T_FH2-n_min is the minimum transport delay between O-RU#2-n and O-RU#1 (n=1, . . . , N); (3) N is the total number of O-RUs connecting O-RU#1, and in this case N=2; (4) T_FH3_min is the minimum transport delay between O-RU#3-1 and O-RU#2-2; (5) If M>1, T_FH3-m min is the minimum transport delay between O-RU#3-m and O-RU#2-2 (m=1, . . . , M); (6) M is the total number of O-RUs connecting to O-RU#2-2, and in this case M=1; (7) T_Copy is O-RUs processing delay for copying which depends on O-RUs capability and is reported via M-Plane; (8) T_FH1_max is the maximum transport delay between O-RU#1 and O-DU; (9) T_FH2-n_max is the maximum transport delay between O-RU#2-n and O-RU#1 (n=1, . . . , N); (10) T_FH3_max is the maximum transport delay between O-RU#3-1 and O-RU#2-2; and (11) If M>1, T_FH3-m_max is the maximum transport delay between O-RU#3-m and O-RU#2-2 (m=1, . . . , M).

FIG. 3C details the UL delay model parameters where O-RU 1 and O-RU 2-2 are operating in hybrid mode, however, O-RU 1 is performing the task of FHM, and O-RU2-2 is operating in a Cascade mode. In examples, for UL U-Plane messages to arrive at the O-DU within the O-DU reception window, the configuration of fronthaul including hybrid O-RUs need to satisfy relationships, similar to those described in section 13.5 of the Support of Shared Cell O-RAN Specification. In examples, it is necessary that inequality equation(s) be satisfied for the UL U-plane message to arrive at the O-DU within the O-DU reception window. In examples, a change will be seen in N (number of southbounded O-RU connecting to north node) which will not be the total number of O-RUs serving the Mth cell. In examples according to FIG. 3C: (1) T_FH1_min is the minimum transport delay between O-RU#1 and O-DU; (2) T_FH2-n min is the minimum transport delay between O-RU#2-n and O-RU#1 (n=1, . . . , N); (3) N is the total number of O-RUs connecting O-RU#1, and in this case N=2; (4) T_FH3_min is the minimum transport delay between O-RU#3-1 and O-RU#2-2; (5) If M>1, T_FH3-m_min is the minimum transport delay between O-RU#3-m and O-RU#2-2 (m=1, . . . , M); (6) M is the total number of O-RUs connecting to O-RU#2-2, and in this case M=1; and (7) T_Comb is O-RUs processing delay for combining UL U-Plane messages which depends on O-RUs capability and is reported via M-Plane; (8) T_FH1_max is the maximum transport delay between O-RU#1 and O-DU; (9) T_FH2-n_max is the maximum transport delay between O-RU#2-n and O-RU#1 (n=1, . . . , N); (10) T_FH3_max is the maximum transport delay between O-RU#3-1 and O-RU#2-2; (11) If M>1, T_FH3-m_max is the maximum transport delay between O-RU#3-m and O-RU#2-2 (m=1, . . . , M); (12) T_Comb is O-RUs processing delay for combining UL U-Plane messages which depends on O-RUs capability and is reported via M-Plane; (13) Ta3_prime_max_O-RU#1 is Ta3_prime_max for O-RU#1; (14) Ta3_prime_max_O-RU#2-2 is Ta3_prime_max for O-RU#2-2; (15) T_FH2-n_max is the maximum transport delay between O-RU#2-n and FHM#1 (n=1, . . . , N); (16) T_FH3-m_max is the maximum transport delay between O-RU#3-m and O-RU#2-2 (m =1, . . . , M); and (16) Ta3_prime_max shall be configured for O-RUs operating in Hybrid mode to support uplink combining operation.

FIG. 4 is a flow diagram illustrating a method 400 for downlink hybrid operation of an RU (such as RU 106-1, hybrid mode RU 204, any quantity of RU 106-2 through optional RU 106-A operating in a hybrid mode, or any quantity of downstream RU 206-1 through optional downstream RU 206-C operating in a hybrid mode). The DU 104 (such as DU 202) may be communicatively coupled to multiple RUs 106 (such as a hybrid mode RU 204 and downstream RUs 206) via a switched network (such as the fronthaul network 118 or fronthaul network 210). The CU 102, DUs 104 (such as DU 202), and RUs 106 (such as hybrid mode RU 204 and downstream RUs 206) may form an O-RAN, etc. The blocks of the flow diagram shown in FIG. 4 have been arranged in a generally sequential manner for ease of explanation; however, it is to be understood that this arrangement is merely exemplary, and it should be recognized that the processing associated with method 400 (and the blocks shown in FIG. 4) can occur in a different order (for example, where at least some of the processing associated with the blocks is performed in parallel and/or in an event-driven manner).

Example method 400 begins at step 402 where downlink control-plan messages, downlink user-plane messages, and uplink control-plane messages are received from the distributed unit at a hybrid radio unit. Example method 400 proceeds to step 404 with wirelessly transmitting downlink radio frequency signals from antenna(s) at the hybrid radio unit based on downlink control-plane and downlink user plane messages. Example method 400 proceeds to step 406 with copying and forwarding downlink control-plane messages, downlink user-plane messages, and uplink control plane messages to a plurality of additional radio units. Example method 400 proceeds to optional step 408 with wirelessly transmitting downlink radio frequency signals from antenna(s) at the additional radio unit(s). Example method 400 proceeds to optional step 410 with copying and forwarding downlink control-plane messages, downlink user-plane messages, and uplink control plane messages to further additional radio unit(s) from the additional radio unit(s).

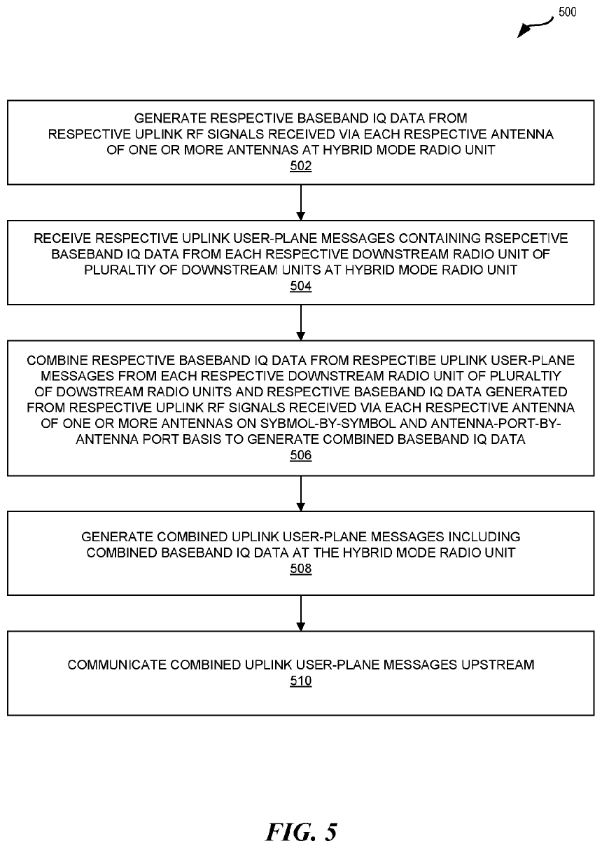

FIG. 5 is a flow diagram illustrating a method 500 for uplink hybrid operation of an RU (such as RU 106-1, hybrid mode RU 204, any quantity of RU 106-2 through optional RU 106-A operating in a hybrid mode, or any quantity of downstream RU 206-1 through optional downstream RU 206-C operating in a hybrid mode). The DU 104 (such as DU 202) may be communicatively coupled to multiple RUs 106 (such as a hybrid mode RU 204 and downstream RUs 206) via a switched network (such as the fronthaul network 118 or fronthaul network 210). The CU 102, DUs 104 (such as DU 202), and RUs 106 (such as hybrid mode RU 204 and downstream RUs 206) may form an O-RAN, etc. The blocks of the flow diagram shown in FIG. 5 have been arranged in a generally sequential manner for ease of explanation; however, it is to be understood that this arrangement is merely exemplary, and it should be recognized that the processing associated with method 500 (and the blocks shown in FIG. 5) can occur in a different order (for example, where at least some of the processing associated with the blocks is performed in parallel and/or in an event-driven manner). The processing associated with method 500 is performed by each hybrid-mode RU for each uplink slot. As noted above, for each uplink slot, the serving DU schedules one or more UEs to transmit during that slot. Also, as noted above, the DU sends uplink control-plane messages to each RU identifying the RBs for which each RU should provide baseband IQ data.

At step 502, for each antenna port, the hybrid-mode RU generates respective baseband IQ data for each front-hauled RB from the uplink RF analog signals received via the respective antennas associated with the hybrid mode RU. That is, the hybrid-mode RU generates, for each antenna (and associated antenna port), respective baseband IQ data from the uplink RF signal received via that antenna. At step 504, the hybrid-mode RU receives, from its southbound RUs, uplink user-plane messages containing baseband IQ data for the front-hauled RBs.

At step 506, the hybrid-mode RU performs a combining process that uses, as inputs the baseband IQ data contained in the received user-plane messages as well as the baseband IQ data generated at the hybrid-mode RU. This combining process is performed, for each front-hauled RB, on a symbol-by-symbol and antenna-port-by-antenna-port basis. That is, for each antenna port, the hybrid-mode RU combines the baseband IQ for each symbol of each front-hauled RB (for example, by digitally summing the corresponding I values received by, and generate at, that hybrid-mode RU for that symbol and by digital summing the corresponding Q values received by, and generated at, that hybrid-mode RU for that symbol).

At step 508, the hybrid-mode RU generates uplink user-plane messages that include the resulting combined baseband IQ data for the various front-hauled RBs and antenna ports and, at step 510, communicates the combined uplink user-plane messages northbound to either the DU (if the hybrid-mode RU is at the top level of the RUs) or to another hybrid-mode RU (if the hybrid-mode RU is not at the top level of the RUs).

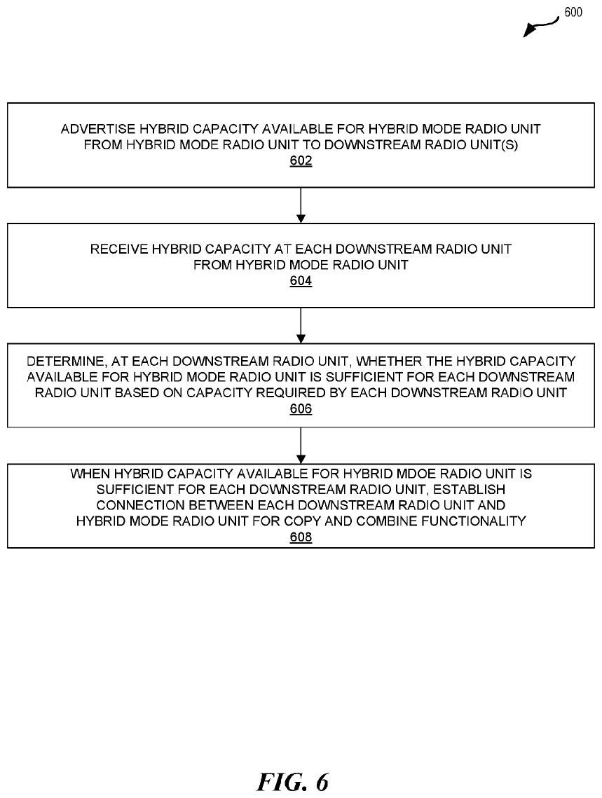

FIG. 6 is a flow diagram illustrating a method 600 for dynamic cluster formation within an O-RAN having a DU and implementing the O-RAN shared cell implementation. The method 600 may be performed by at least one processor in at least one RU 106 (such as a hybrid mode RU 204). The DU 104 (such as a DU 202) may be communicatively coupled to multiple RUs 106 (such as a hybrid mode RU 204 and downstream RUs 206) via a switched network (such as the fronthaul network 118 or fronthaul network 210). The CU 102, DUs 104 (such as a DU 202), and RUs 106 (such as a hybrid mode RU 204 and downstream RUs 206) may form an O-RAN, etc.

The blocks of the flow diagram shown in FIG. 6 have been arranged in a generally sequential manner for ease of explanation; however, it is to be understood that this arrangement is merely exemplary, and it should be recognized that the processing associated with method 600 (and the blocks shown in FIG. 6) can occur in a different order (for example, where at least some of the processing associated with the blocks is performed in parallel and/or in an event-driven manner). Also, most standard exception handling is not described for ease of explanation; however, it is to be understood that method 600 can and typically would include such exception handling.

Example method 600 begins at step 602 where the at least one processor advertises hybrid capacity available for a hybrid mode RU (such as hybrid mode RU 204 in FIG. 2 or RU 106-1 in FIG. 1A or FIG. 1B) from the hybrid mode RU (such as hybrid mode RU 204 or RU 106-1) to downstream RUs (such as downstream RU 206 in FIG. 2 or RU 106-2 in FIG. 1A or FIG. 1B), wherein the hybrid mode RU (such as hybrid mode RU 204 or RU 106-1) is communicatively coupled to the DU (such as DU 202 in FIG. 2 or DU 104 in FIG. 1A or FIG. 1B) within an open radio access network (O-RAN), wherein each downstream RU (such as downstream RU 206-1 or RU 106-2) is communicatively coupled to the DU (such as DU 202 or DU 104) via the hybrid mode RU (such as hybrid mode RU 204 or RU 106-1). Example method 600 proceeds to step 604 with receiving advertisement for capacity available for copy and combine functions for downstream RUs at each downstream RU (such as downstream RU 206-1 or RU 106-2) from the hybrid mode RU (such as hybrid mode RU 204 or RU 106-1).

Example method 600 proceeds to step 606 with determining, at each respective downstream RU (such as downstream RU 206-1 or RU 106-2), whether the capacity available for copy and combine functions for downstream RUs at the hybrid mode RU (such as hybrid mode RU 204 or RU 106-1) is sufficient for the respective downstream RU (such as downstream RU 206-1 or RU 106-2) based on capacity required by the downstream RU (such as downstream RU 206-1 or RU 106-2). Example method 600 proceeds to step 608 with when the hybrid capacity available for the hybrid mode RU (such as hybrid mode RU 204 or RU 106-1) is sufficient for the respective downstream RU (such as downstream RU 206-1 or RU 106-2), establish a connection between the respective downstream RU (such as downstream RU 206-1 or RU 106-2) and the hybrid mode RU (such as hybrid mode RU 204 or RU 106-1) for copy and combine functionality.

In examples implementing hierarchical clustering, the DU communicates configuration metrics to multiple hybrid mode RUs at different hops (such as hybrid mode RU 204 and downstream RU 206-1 operating as a hybrid mode RU) and the multiple hybrid mode RUs (such as hybrid mode RU 204 and downstream RU 206-1 operating as a hybrid mode RU) can group at different levels based on the metrics, such as the number of hops from the DU 202 and/or the maximum delay from the DU 202. In examples, multiple hybrid mode RUs can be created at the same level based on deployment requirements. In examples, the processing associated with method 600 is performed by and for each RU in the network.

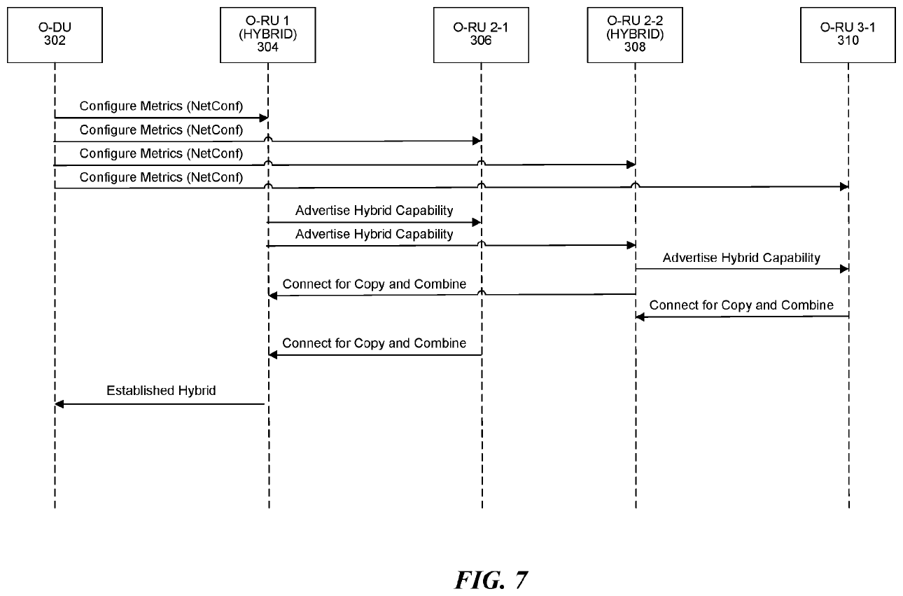

FIG. 7 illustrates one example of the dynamic cluster formation processing of method 600 being performed in the example system of FIG. 3A. In this example, as a result of the dynamic cluster formation processing of method 600, O-RU 1 (HYBRID) 304 serves as a cluster head, and performs the copy (downlink) and combine (uplink) processing, for O-RU 2-1 306, and for O-RU 2-2 (HYBRID) 308. In addition, O-RU 2-2 (HYBRID) 308 serves as cluster head, and performs the copy (downlink) and combine (uplink) processing, for O-RU 3-1 310. The O-DU 302 configures each O-RU (including O-RU 1 (HYBRID) 304, O-RU 2-1 306, O-RU 2-2 (HYBRID) 308, and O-RU 3-1 310). Each O-RU that has a south link sends indication to its north bounded O-RU after connecting with its south bounded O-RU(s).

### Terminology

Brief definitions of terms, abbreviations, and phrases used throughout this application are given below.

The term “determining” and its variants may include calculating, extracting, generating, computing, processing, deriving, modeling, investigating, looking up (e.g., looking up in a table, a database or another data structure), ascertaining and the like. Also, “determining” may also include receiving (e.g., receiving information), accessing (e.g., accessing data in a memory) and the like. Also, “determining” may include resolving, selecting, choosing, establishing and the like.

The phrase “based on” does not mean “based only on,” unless expressly specified otherwise. In other words, the phrase “based on” describes both “based only on” and “based at least on”. Additionally, the term “and/or” means “and” or “or”. For example, “A and/or B” can mean “A”, “B”, or “A and B”. Additionally, “A, B, and/or C” can mean “A alone,” “B alone,” “C alone,” “A and B,” “A and C,” “B and C” or “A, B, and C.”

The terms “connected”, “coupled”, and “communicatively coupled” and related terms may refer to direct or indirect connections. If the specification states a component or feature “may,” “can,” “could,” or “might” be included or have a characteristic, that particular component or feature is not required to be included or have the characteristic.

The terms “responsive” or “in response to” may indicate that an action is performed completely or partially in response to another action. The term “module” refers to a functional component implemented in software, hardware, or firmware (or any combination thereof) component.

The methods disclosed herein comprise one or more steps or actions for achieving the described method. Unless a specific order of steps or actions is required for proper operation of the method that is being described, the order and/or use of specific steps and/or actions may be modified without departing from the scope of the claims.

While detailed descriptions of one or more configurations of the disclosure have been given above, various alternatives, modifications, and equivalents will be apparent to those skilled in the art without varying from the spirit of the disclosure. For example, while the configurations described above refer to particular features, functions, procedures, components, elements, and/or structures, the scope of this disclosure also includes configurations having different combinations of features, functions, procedures, components, elements, and/or structures, and configurations that do not include all of the described features, functions, procedures, components, elements, and/or structures. Accordingly, the scope of the present disclosure is intended to embrace all such alternatives, modifications, and variations as fall within the scope of the claims, together with all equivalents thereof. Therefore, the above description should not be taken as limiting.

### EXAMPLES

Example 1 includes an open radio access network implementing a shared cell, the open radio access network comprising: a distributed unit; a plurality of radio units communicatively coupled to the distributed unit, wherein each of the plurality of radio units includes circuitry for exchanging radio frequency signals with at least one user equipment, wherein the plurality of radio units includes: a hybrid mode radio unit communicatively coupled to the distributed unit; a first downstream radio unit communicatively coupled to the hybrid mode radio unit, the first downstream radio unit communicatively coupled to the distributed unit via the hybrid mode radio unit; and a second downstream radio unit communicatively coupled to the hybrid mode radio unit, the second downstream radio unit communicatively coupled to the distributed unit via the hybrid mode radio unit; and wherein the hybrid mode radio unit is configured to: receive downlink control-plane messages, downlink user-plane messages, and uplink control-plane messages from the distributed unit; transmit downlink radio frequency signals from one or more antennas, wherein the downlink radio frequency signals are based on the downlink control-plane messages and the downlink user-plane messages; and copy and forward the downlink control-plane messages, the downlink user-plane messages, and the uplink control-plane messages to a plurality of downstream radio units of the plurality of radio units.

Example 2 includes the open radio access network of Example 1, wherein the hybrid mode radio unit is further configured to: generate first respective baseband IQ data from respective uplink RF signals received via each respective antenna of the one or more antennas; receive respective uplink user-plane messages containing second respective baseband IQ data from each respective downstream radio unit of the plurality of downstream radio units; combine the second respective baseband IQ data from the respective uplink user-plane messages from each respective downstream radio unit of the plurality of downstream radio units and the first respective baseband IQ data generated from the respective uplink RF signals received via each respective antenna of the one or more antennas on a symbol-by-symbol and antenna-port-by-antenna-port basis to generate combined baseband IQ data; generate combined uplink user-plane messages including the combined baseband IQ data; communicate the combined uplink user-plane messages to the distributed unit.

Example 3 includes the open radio access network of any of Examples 1-2, wherein the hybrid mode radio unit is further configured to: advertise capacity available for copy and combine functions for downstream radio units to the first downstream radio unit; receive indication from the first downstream radio unit that the capacity available for the copy and combine functions is sufficient to meet requirements for first copy and combine functions of the first downstream radio unit; and establish a connection between the hybrid mode radio unit and the first downstream radio unit when the capacity available for the copy and combine functions is sufficient to meet the requirements for the first copy and combine functions of the first downstream radio unit.

Example 4 includes the open radio access network of any of Examples 1-3, wherein the hybrid mode radio unit is configured to: advertise capacity available for copy and combine functions for downstream radio units to the first downstream radio unit; advertise the capacity available for the copy and combine functions to the second downstream radio unit; receive indication from the first downstream radio unit that the capacity available for the copy and combine functions is not sufficient to meet requirements for first copy and combine functions of the first downstream radio unit; receive indication from the second downstream radio unit that the capacity available for the copy and combine functions is sufficient to meet the requirements for second copy and combine functions of the second downstream radio unit; and establish a connection between the hybrid mode radio unit and the second downstream radio unit when the capacity available for the copy and combine functions is sufficient to meet the requirements for the second copy and combine functions of the second downstream radio unit.

Example 5 includes the open radio access network of any of Examples 1-4, wherein the first downstream radio unit is configured to: receive an advertisement of capacity available for copy and combine functions for downstream radio units from a hybrid mode radio unit; determine whether first capacity available for the hybrid mode radio unit is sufficient for the first downstream radio unit based on second capacity required by the first downstream radio unit; communicate an indication that the capacity available for the copy and combine functions is sufficient to meet requirements for first copy and combine functions of the first downstream radio unit; and establish a connection between the first downstream radio unit and the hybrid mode radio unit when the capacity available for the copy and combine functions is sufficient to meet the requirements for the first copy and combine functions of the first downstream radio unit.

Example 6 includes the open radio access network of any of Examples 1-5, wherein: the hybrid mode radio unit is configured to: advertise capacity available for copy and combine functions for downstream radio units to the first downstream radio unit; receive indication from the first downstream radio unit that the capacity available for the copy and combine functions is sufficient to meet requirements for first copy and combine functions of the first downstream radio unit; and establish a connection between the hybrid mode radio unit and the first downstream radio unit when the capacity available for the copy and combine functions is sufficient to meet the requirements for the first copy and combine functions of the first downstream radio unit; and wherein the first downstream radio unit is configured to: receive an advertisement of the capacity available for the copy and combine functions for the downstream radio units from the hybrid mode radio unit; determine whether first capacity available for the hybrid mode radio unit is sufficient for the first downstream radio unit based on second capacity required by the first downstream radio unit; communicate an indication that the capacity available for the copy and combine functions is sufficient to meet the requirements for the first copy and combine functions of the first downstream radio unit; and establish a connection between the first downstream radio unit and the hybrid mode radio unit when the capacity available for the copy and combine functions is sufficient to meet the requirements for the first copy and combine functions of the first downstream radio unit.

Example 7 includes the open radio access network of any of Examples 1-6, wherein the distributed unit is configured to operate in a 3GPP Fifth Generation communication system.

Example 8 includes the open radio access network of any of Examples 1-7, wherein the plurality of radio units are communicatively coupled together and to the distributed unit using at least one Ethernet switch.

Example 9 includes a radio unit for use within an open radio access network having a distributed unit and implementing a shared cell, the radio unit comprising: circuitry configured to: receive downlink control-plane messages, downlink user-plane messages, and uplink control-plane messages from the distributed unit; transmit downlink radio frequency signals from one or more antennas, wherein the downlink radio frequency signals are based on the downlink control-plane messages and the downlink user-plane messages; and copy and forward the downlink control-plane messages, the downlink user-plane messages, and the uplink control-plane messages to a plurality of downstream radio units.

Example 10 includes the radio unit of Example 9, wherein the circuitry is further configured to: generate first respective baseband IQ data from respective uplink RF signals received via each respective antenna of the one or more antennas; receive respective uplink user-plane messages containing second respective baseband IQ data from each respective downstream radio unit of the plurality of downstream radio units; combine the second respective baseband IQ data from the respective uplink user-plane messages from each respective downstream radio unit of the plurality of downstream radio units and the first respective baseband IQ data generated from the respective uplink RF signals received via each respective antenna of the one or more antennas on a symbol-by-symbol and antenna-port-by-antenna-port basis to generate combined baseband IQ data; generate combined uplink user-plane messages including the combined baseband IQ data; communicate the combined uplink user-plane messages to the distributed unit.

Example 11 includes the radio unit of any of Examples 9-10, wherein the circuitry is further configured to: advertise capacity available for copy and combine functions for downstream radio units to a first downstream radio unit; receive indication from the first downstream radio unit that the capacity available for the copy and combine functions is sufficient to meet requirements for first copy and combine functions of the first downstream radio unit; and establish a connection between the radio unit and the first downstream radio unit when the capacity available for the copy and combine functions is sufficient to meet the requirements for the first copy and combine functions of the first downstream radio unit.

Example 12 includes the radio unit of any of Examples 9-11, wherein the distributed unit is configured to operate in a 3GPP Fifth Generation communication system.

Example 13 includes the radio unit of any of Examples 9-12, wherein the radio unit is communicatively coupled to the distributed unit and the plurality of downstream radio units using at least one Ethernet switch.

Example 14 includes a downstream radio unit for use within an open radio access network having a distributed unit and implementing a shared cell, the downstream radio unit comprising: circuitry configured to: receive an advertisement of capacity available for copy and combine functions for downstream radio units from a hybrid mode radio unit; determine whether first capacity available for the hybrid mode radio unit is sufficient for the downstream radio unit based on second capacity required by the downstream radio unit; communicate an indication that the capacity available for the copy and combine functions is sufficient to meet requirements for first copy and combine functions of the downstream radio unit; and establish a connection between the downstream radio unit and the hybrid mode radio unit when the capacity available for the copy and combine functions is sufficient to meet the requirements for the first copy and combine functions of the downstream radio unit.

Example 15 includes the downstream radio unit of Example 14, wherein the distributed unit is configured to operate in a 3GPP Fifth Generation communication system.

Example 16 includes the downstream radio unit of any of Examples 14-15, wherein the downstream radio unit is communicatively coupled to the hybrid mode radio unit using at least one Ethernet switch.

Example 17 includes a method for communication within an open radio access network having a distributed unit and implementing a shared cell, the method comprising: receiving downlink control-plane messages, downlink user-plane messages, and uplink control-plane messages from the distributed unit at a radio unit; transmitting downlink radio frequency signals from one or more antennas at the radio unit, wherein the downlink radio frequency signals are based on the downlink control-plane messages and the downlink user-plane messages; and copying and forwarding the downlink control-plane messages, the downlink user-plane messages, and the uplink control-plane messages from the radio unit to a plurality of downstream radio units.

Example 18 includes the method of Example 17, further comprising: generating first respective baseband IQ data from respective uplink RF signals received via each respective antenna of the one or more antennas; receiving respective uplink user-plane messages containing second respective baseband IQ data from each respective downstream radio unit of the plurality of downstream radio units; combine the second respective baseband IQ data from the respective uplink user-plane messages from each respective downstream radio unit of the plurality of downstream radio units and the first respective baseband IQ data generated from the respective uplink RF signals received via each respective antenna of the one or more antennas on a symbol-by-symbol and antenna-port-by-antenna-port basis to generate combined baseband IQ data; generate combined uplink user-plane messages including the combined baseband IQ data; communicate the combined uplink user-plane messages to the distributed unit.

Example 19 includes the method of any of Examples 17-18, further comprising: advertising capacity available for copy and combine functions for downstream radio units from the radio unit to a downstream radio unit, wherein the radio unit is communicatively coupled to the distributed unit within the open radio access network, wherein the downstream radio unit is communicatively coupled to the distributed unit via the radio unit; receiving advertisement of the capacity available for the copy and combine functions for the downstream radio units at the downstream radio unit from the radio unit; determining, at the downstream radio unit, whether the capacity available for the copy and combine functions for the downstream radio units is sufficient for the downstream radio unit based on first capacity required by the downstream radio unit; and when the capacity available for the copy and combine functions for the downstream radio units is sufficient for the downstream radio unit, establish a connection between the downstream radio unit and the radio unit for the copy and combine functions.

Example 20 includes the method of any of Examples 17-19, wherein the distributed unit is configured to operate in a 3GPP Fifth Generation communication system.

What is claimed is:

1. An open radio access network implementing a shared cell, the open radio access network comprising:
a distributed unit;
a plurality of radio units communicatively coupled to the distributed unit, wherein each of the plurality of radio units includes circuitry for exchanging radio frequency signals with at least one user equipment, wherein the plurality of radio units includes:
a hybrid mode radio unit communicatively coupled to the distributed unit;
a first downstream radio unit communicatively coupled to the hybrid mode radio unit, the first downstream radio unit communicatively coupled to the distributed unit via the hybrid mode radio unit; and
a second downstream radio unit communicatively coupled to the hybrid mode radio unit, the second downstream radio unit communicatively coupled to the distributed unit via the hybrid mode radio unit; and
wherein the hybrid mode radio unit is configured to:
receive downlink control-plane messages, downlink user-plane messages, and uplink control-plane messages from the distributed unit;
transmit downlink radio frequency signals from one or more antennas, wherein the downlink radio frequency signals are based on the downlink control-plane messages and the downlink user-plane messages; and
copy and forward the downlink control-plane messages, the downlink user-plane messages, and the uplink control-plane messages to a plurality of downstream radio units of the plurality of radio units.

2. The open radio access network of claim 1, wherein the hybrid mode radio unit is further configured to:
generate first respective baseband IQ data from respective uplink RF signals received via each respective antenna of the one or more antennas;
receive respective uplink user-plane messages containing second respective baseband IQ data from each respective downstream radio unit of the plurality of downstream radio units;
combine the second respective baseband IQ data from the respective uplink user-plane messages from each respective downstream radio unit of the plurality of downstream radio units and the first respective baseband IQ data generated from the respective uplink RF signals received via each respective antenna of the one or more antennas on a symbol-by-symbol and antenna-port-by-antenna-port basis to generate combined baseband IQ data;
generate combined uplink user-plane messages including the combined baseband IQ data;
communicate the combined uplink user-plane messages to the distributed unit.

3. The open radio access network of claim 1, wherein the hybrid mode radio unit is further configured to:
advertise capacity available for copy and combine functions for downstream radio units to the first downstream radio unit;
receive indication from the first downstream radio unit that the capacity available for the copy and combine functions is sufficient to meet requirements for first copy and combine functions of the first downstream radio unit; and
establish a connection between the hybrid mode radio unit and the first downstream radio unit when the capacity available for the copy and combine functions is sufficient to meet the requirements for the first copy and combine functions of the first downstream radio unit.

4. The open radio access network of claim 1, wherein the hybrid mode radio unit is configured to:
advertise capacity available for copy and combine functions for downstream radio units to the first downstream radio unit;
advertise the capacity available for the copy and combine functions to the second downstream radio unit;
receive indication from the first downstream radio unit that the capacity available for the copy and combine functions is not sufficient to meet requirements for first copy and combine functions of the first downstream radio unit;
receive indication from the second downstream radio unit that the capacity available for the copy and combine functions is sufficient to meet the requirements for second copy and combine functions of the second downstream radio unit; and
establish a connection between the hybrid mode radio unit and the second downstream radio unit when the capacity available for the copy and combine functions is sufficient to meet the requirements for the second copy and combine functions of the second downstream radio unit.

5. The open radio access network of claim 1, wherein the first downstream radio unit is configured to:
receive an advertisement of capacity available for copy and combine functions for downstream radio units from a hybrid mode radio unit;
determine whether first capacity available for the hybrid mode radio unit is sufficient for the first downstream radio unit based on second capacity required by the first downstream radio unit;
communicate an indication that the capacity available for the copy and combine functions is sufficient to meet requirements for first copy and combine functions of the first downstream radio unit; and
establish a connection between the first downstream radio unit and the hybrid mode radio unit when the capacity available for the copy and combine functions is sufficient to meet the requirements for the first copy and combine functions of the first downstream radio unit.

6. The open radio access network of claim 1, wherein:
the hybrid mode radio unit is configured to:
advertise capacity available for copy and combine functions for downstream radio units to the first downstream radio unit;
receive indication from the first downstream radio unit that the capacity available for the copy and combine functions is sufficient to meet requirements for first copy and combine functions of the first downstream radio unit; and
establish a connection between the hybrid mode radio unit and the first downstream radio unit when the capacity available for the copy and combine functions is sufficient to meet the requirements for the first copy and combine functions of the first downstream radio unit; and
wherein the first downstream radio unit is configured to:
receive an advertisement of the capacity available for the copy and combine functions for the downstream radio units from the hybrid mode radio unit;
determine whether first capacity available for the hybrid mode radio unit is sufficient for the first downstream radio unit based on second capacity required by the first downstream radio unit;
communicate an indication that the capacity available for the copy and combine functions is sufficient to meet the requirements for the first copy and combine functions of the first downstream radio unit; and
establish a connection between the first downstream radio unit and the hybrid mode radio unit when the capacity available for the copy and combine functions is sufficient to meet the requirements for the first copy and combine functions of the first downstream radio unit.

7. The open radio access network of claim 1, wherein the distributed unit is configured to operate in a 3GPP Fifth Generation communication system.

8. The open radio access network of claim 1, wherein the plurality of radio units are communicatively coupled together and to the distributed unit using at least one Ethernet switch.

9. A radio unit for use within an open radio access network having a distributed unit and implementing a shared cell, the radio unit comprising:
circuitry configured to:
receive downlink control-plane messages, downlink user-plane messages, and uplink control-plane messages from the distributed unit;
transmit downlink radio frequency signals from one or more antennas, wherein the downlink radio frequency signals are based on the downlink control-plane messages and the downlink user-plane messages; and
copy and forward the downlink control-plane messages, the downlink user-plane messages, and the uplink control-plane messages to a plurality of downstream radio units.

10. The radio unit of claim 9, wherein the circuitry is further configured to:
generate first respective baseband IQ data from respective uplink RF signals received via each respective antenna of the one or more antennas;
receive respective uplink user-plane messages containing second respective baseband IQ data from each respective downstream radio unit of the plurality of downstream radio units;
combine the second respective baseband IQ data from the respective uplink user-plane messages from each respective downstream radio unit of the plurality of downstream radio units and the first respective baseband IQ data generated from the respective uplink RF signals received via each respective antenna of the one or more antennas on a symbol-by-symbol and antenna-port-by-antenna-port basis to generate combined baseband IQ data;
generate combined uplink user-plane messages including the combined baseband IQ data;
communicate the combined uplink user-plane messages to the distributed unit.

11. The radio unit of claim 9, wherein the circuitry is further configured to:
advertise capacity available for copy and combine functions for downstream radio units to a first downstream radio unit;
receive indication from the first downstream radio unit that the capacity available for the copy and combine functions is sufficient to meet requirements for first copy and combine functions of the first downstream radio unit; and
establish a connection between the radio unit and the first downstream radio unit when the capacity available for the copy and combine functions is sufficient to meet the requirements for the first copy and combine functions of the first downstream radio unit.

12. The radio unit of claim 9, wherein the distributed unit is configured to operate in a 3GPP Fifth Generation communication system.

13. The radio unit of claim 9, wherein the radio unit is communicatively coupled to the distributed unit and the plurality of downstream radio units using at least one Ethernet switch.

14. A downstream radio unit for use within an open radio access network having a distributed unit and implementing a shared cell, the downstream radio unit comprising:
circuitry configured to:
receive an advertisement of capacity available for copy and combine functions for downstream radio units from a hybrid mode radio unit;
determine whether first capacity available for the hybrid mode radio unit is sufficient for the downstream radio unit based on second capacity required by the downstream radio unit;
communicate an indication that the capacity available for the copy and combine functions is sufficient to meet requirements for first copy and combine functions of the downstream radio unit; and
establish a connection between the downstream radio unit and the hybrid mode radio unit when the capacity available for the copy and combine functions is sufficient to meet the requirements for the first copy and combine functions of the downstream radio unit.

15. The downstream radio unit of claim 14, wherein the distributed unit is configured to operate in a 3GPP Fifth Generation communication system.

16. The downstream radio unit of claim 14, wherein the downstream radio unit is communicatively coupled to the hybrid mode radio unit using at least one Ethernet switch.

17. A method for communication within an open radio access network having a distributed unit and implementing a shared cell, the method comprising:
receiving downlink control-plane messages, downlink user-plane messages, and uplink control-plane messages from the distributed unit at a radio unit;
transmitting downlink radio frequency signals from one or more antennas at the radio unit, wherein the downlink radio frequency signals are based on the downlink control-plane messages and the downlink user-plane messages; and
copying and forwarding the downlink control-plane messages, the downlink user-plane messages, and the uplink control-plane messages from the radio unit to a plurality of downstream radio units.

18. The method of claim 17, further comprising:
generating first respective baseband IQ data from respective uplink RF signals received via each respective antenna of the one or more antennas;
receiving respective uplink user-plane messages containing second respective baseband IQ data from each respective downstream radio unit of the plurality of downstream radio units;
combine the second respective baseband IQ data from the respective uplink user-plane messages from each respective downstream radio unit of the plurality of downstream radio units and the first respective baseband IQ data generated from the respective uplink RF signals received via each respective antenna of the one or more antennas on a symbol-by-symbol and antenna-port-by-antenna-port basis to generate combined baseband IQ data;
generate combined uplink user-plane messages including the combined baseband IQ data;
communicate the combined uplink user-plane messages to the distributed unit.

19. The method of claim 17, further comprising:
advertising capacity available for copy and combine functions for downstream radio units from the radio unit to a downstream radio unit, wherein the radio unit is communicatively coupled to the distributed unit within the open radio access network, wherein the downstream radio unit is communicatively coupled to the distributed unit via the radio unit;
receiving advertisement of the capacity available for the copy and combine functions for the downstream radio units at the downstream radio unit from the radio unit;
determining, at the downstream radio unit, whether the capacity available for the copy and combine functions for the downstream radio units is sufficient for the downstream radio unit based on first capacity required by the downstream radio unit; and
when the capacity available for the copy and combine functions for the downstream radio units is sufficient for the downstream radio unit, establish a connection between the downstream radio unit and the radio unit for the copy and combine functions.

20. The method of claim 17, wherein the distributed unit is configured to operate in a 3GPP Fifth Generation communication system.
